(19) United States
(12) Patent Application Publication
(10) Pub. No.: US 2021/0252906 A1
(43) Pub. Date: Aug. 19, 2021

(54) ROLLER WETTING DAM

(71) Applicant: Billy Machner, Browns Mills, NJ (US)

(72) Inventor: Billy Machner, Browns Mills, NJ (US)

(21) Appl. No.: 17/179,128

(22) Filed: Feb. 18, 2021

Related U.S. Application Data
(60) Provisional application No. 62/978,164, filed on Feb. 18, 2020.

(51) Int. Cl. B44D 3/12

(52) U.S. Cl. CPC B44D 3/126

(57) ABSTRACT

Roller wetting dams are presented including: a curved paint shield, the curved paint shield defining a front surface, a back surface, a proximal edge, a distal edge, a top edge, and a bottom edge; a proximal side shield positioned along a portion of the proximal edge and extended from the top edge, where the proximal side shield is substantially perpendicular with the curved paint shield; a distal side shield positioned along a portion of the distal edge and extended from the top edge, the distal side shield substantially perpendicular with the curved paint shield; and a number of trailing arms coupled to the back surface of the curved paint shield extending backward from and substantially perpendicular to the curved paint shield.

### FIELD OF INVENTION

Embodiments of the present invention relate to paint trays. More specifically to paint trays using rollers.

### BACKGROUND

Typically, the proper way to load a paint roller is to place the roller into a paint tray a quarter at a time and rolling the paint onto the surface of the roller. However, often the paint roller gets loaded with paint on one section of the roller preventing the unloaded section of the roller from reaching the paint. Often, the only way to get the paint roller fully loaded is to use a finger to hold the roller in place while dipping the roller in the paint tray. Thus, using conventional methods, either the paint roller is unequally loaded, or a messy situation is created by directly handling the roller. In both cases, an uneven coating of paint delivered to a working surface is created.

As such paint trays with wetting dams are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, roller wetting dams are presented including: a curved paint shield, the curved paint shield defining a front surface, a back surface, a proximal edge, a distal edge, a top edge, and a bottom edge; a proximal side shield positioned along a portion of the proximal edge and extended from the top edge, where the proximal side shield is substantially perpendicular with the curved paint shield; a distal side shield positioned along a portion of the distal edge and extended from the top edge, the distal side shield substantially perpendicular with the curved paint shield; and a number of trailing arms coupled to the back surface of the curved paint shield extending backward from and substantially perpendicular to the curved paint shield, where each of the number of trailing arms includes a slot positioned along a rear portion of the trailing arm; and a number of supports positioned between the number of trailing arms forward of the slots, where the number of supports are substantially parallel with the curved paint shield. In some embodiment, the top edge is wider than the bottom edge such that an opening is defined to provide for liquid flow. In some embodiments, roller wetting dams further include: a proximal tray clip positioned on the proximal side shield; and a distal tray clip positioned on the distal side shield, where the proximal tray clip and the distal tray clip removably couple the roller wetting dam with a paint tray.

In other embodiments, roller wetting systems are presented including: a paint tray including: a removable paper towel holder, the removable paper towel holder including a pair of roller support arms positioned along a back portion of the paint tray and extending backward from the back portion; and roller wetting dam including: a curved paint shield, the curved paint shield defining a front surface, a back surface, a proximal edge, a distal edge, a top edge, and a bottom edge; a proximal side shield positioned along a portion of the proximal edge and extended from the top edge, where the proximal side shield is substantially perpendicular with the curved paint shield; a distal side shield positioned along a portion of the distal edge and extended from the top edge, the distal side shield substantially perpendicular with the curved paint shield; and a number of trailing arms conforming to the back surface of the curved paint shield extending backward from and substantially perpendicular to the curved paint shield, where each of the number of trailing arms includes a slot positioned along a rear portion of the trailing arm; and a number of support beams positioned between the number of trailing arms forward of the slots, where the number of support beams are substantially parallel with the curved paint shield.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1B are illustrative representations of a roller wetting system for applying coatings to a paint roller in accordance with embodiments of the present invention;

FIG. 2 is an illustrative representation of a wetting dam and paint tray for applying coatings to a paint roller in accordance with embodiments of the present invention;

FIGS. 3A-3B are illustrative representations of a wetting dam in accordance with embodiments of the present invention;

FIG. 4 is an illustrative representation of a paint tray and liner in accordance with embodiments of the present invention;

FIG. 5 is an illustrative representation of a paint tray and liner in accordance with embodiments of the present invention;

FIGS. 6A-6B are illustrative representations of a wetting dam in accordance with embodiments of the present invention; and

FIG. 7 is an illustrative representation of a roller wetting system applying coatings to a paint roller in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

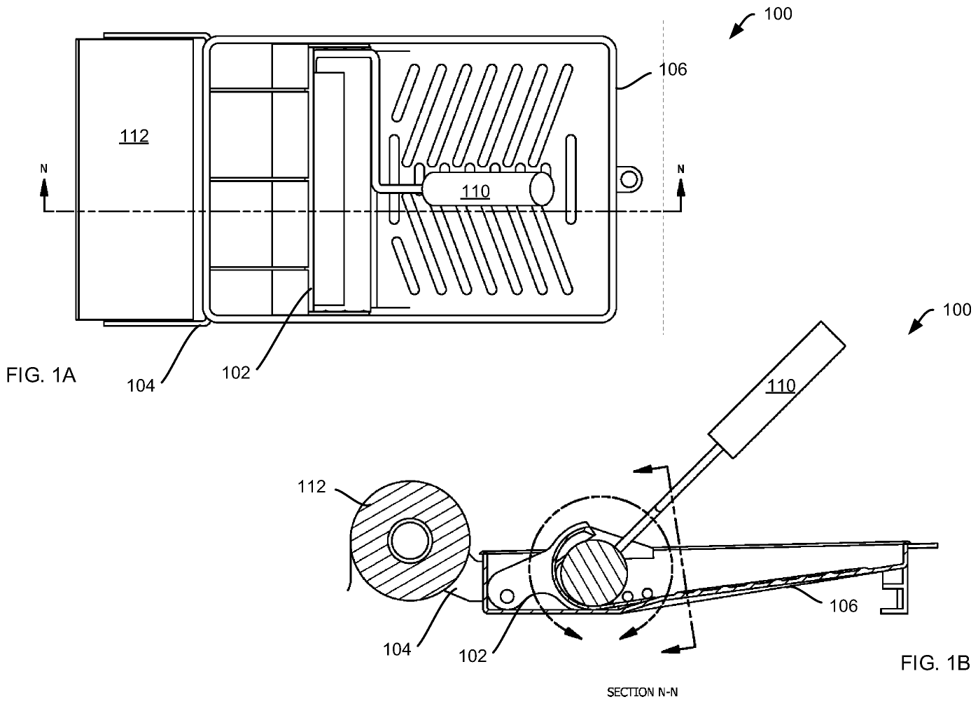

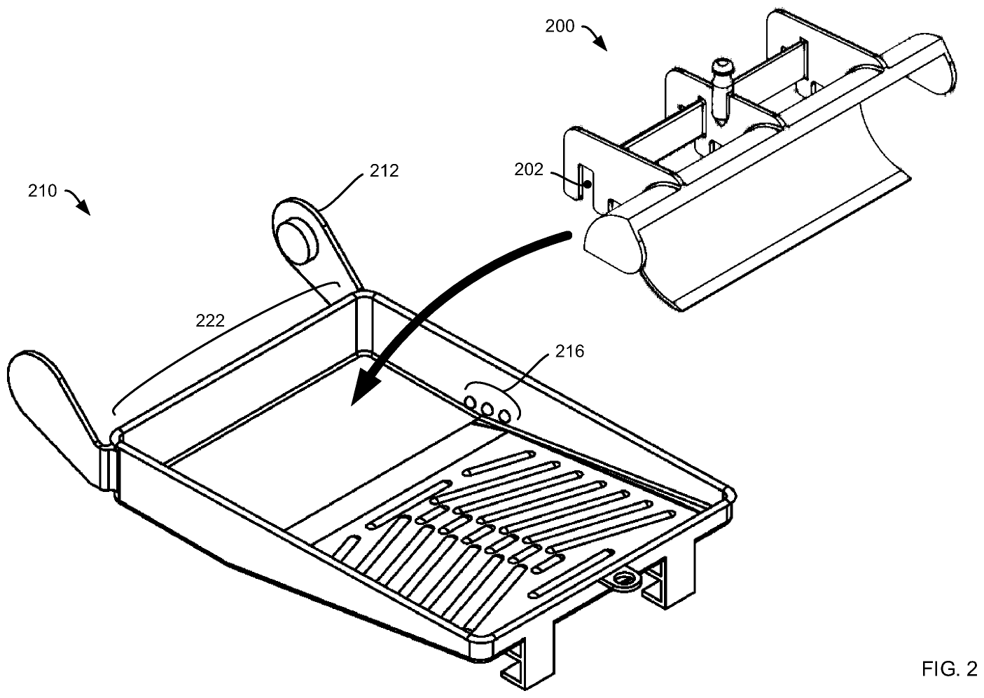

FIGS. 1A-1B are illustrative representations of a roller wetting system applying coatings to a paint roller in accordance with embodiments of the present invention. In particular FIG. 1A is an illustrative top plan view of roller wetting system 100 and FIG. 1B is an illustrative side view of roller wetting system 100. As illustrated, roller wetting system 100 includes wetting dam 102. It may be appreciated that conventional paint trays rely on the deep portion of the paint tray to load a roller with a coating. One problem is that the roller tends to slip on the surface of the paint tray so only one side of the roller is loaded. Another problem is that when the roller is pushed forward in the tray, the liquid coating may spill over the sides. Wetting dam embodiments prevent both problems and load the roller evenly. As shown, roller 110 is in a deep portion of paint tray 106. As roller 110 is pushed toward wetting dam 102, the liquid coating gathers along wetting dam 102 and overflows onto the nap of roller 110. The roller is loaded with liquid coating and avoids spilling because the liquid coating is contained within the deep portion of the paint tray. As utilized herein, liquid coatings refers to any liquid that is suitable applied using a roller such as is illustrated here. Thus, liquid coatings may include any of paints, sealers, and solvents without limitation and without departing from embodiments disclosed herein. Further illustrated is removable paper towel holder 112. Removable paper towel holder embodiments may be mechanically coupled with paint tray 106 in any fashion known in the art such as, for example, by using a magnetic attachment, by bolting, by screwing, by using a sliding engagement, etc.

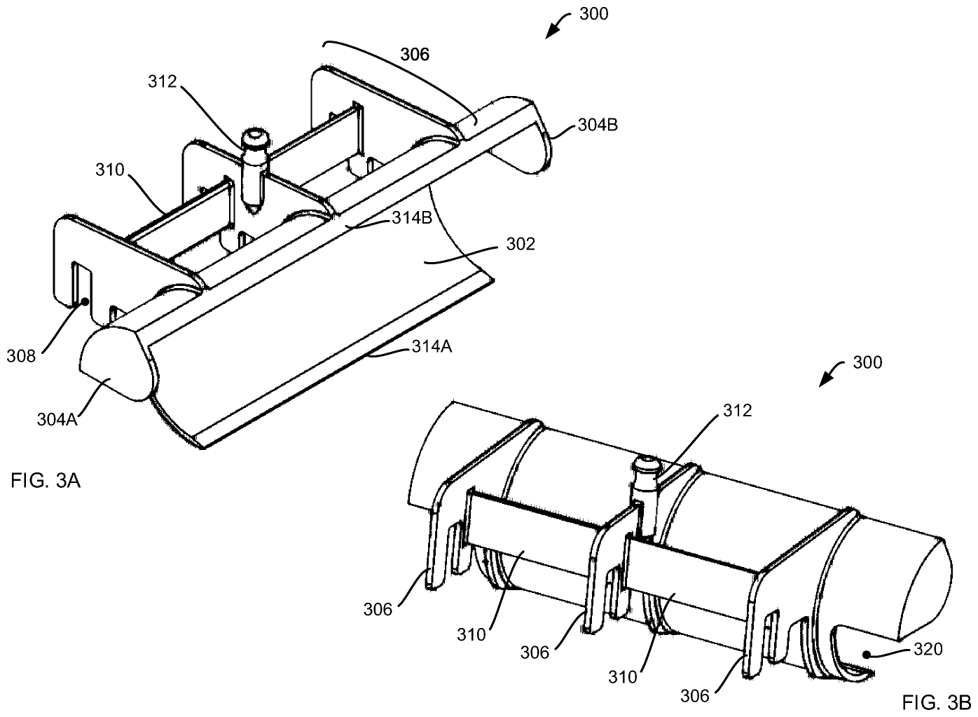

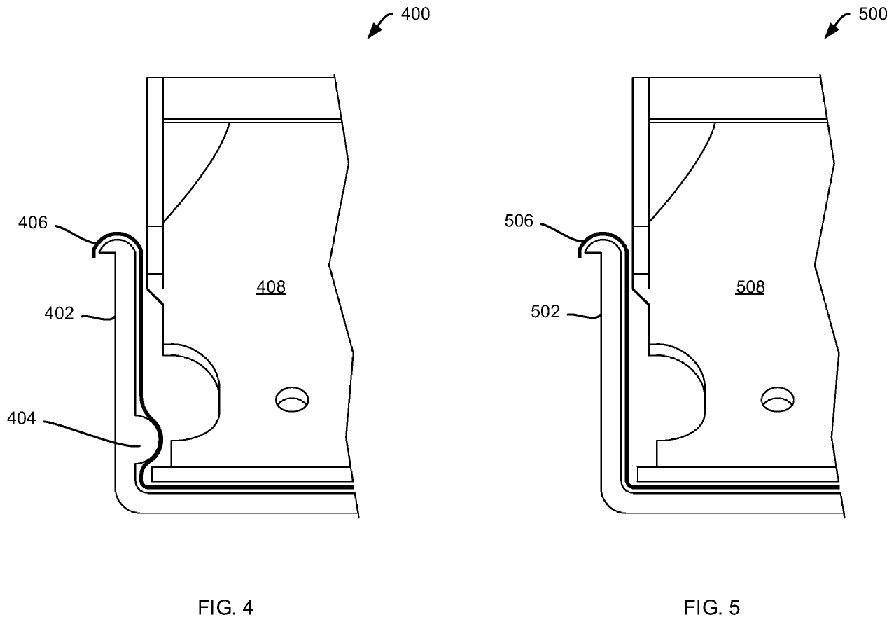

FIG. 2 is an illustrative representation of wetting dam 200 and paint tray 210 for applying coatings to a paint roller in accordance with embodiments of the present invention. This illustration is provided for clarification in understanding the separate components of roller wetting system embodiments. As illustrated, wetting dam 200 is placed in paint tray 210 and removably secured using slots 202 engaged along back edge 212 of paint tray 210. Wetting dam embodiments with be discussed in further detail below for FIGS. 3A-3B. Further illustrated, paint tray 210 includes removable paper towel holder 214 and optional nubs 216. Optional nubs will be discussed in further detail below for FIGS. 4-5.

FIGS. 3A-3B are illustrative representations of wetting dam 300 in accordance with embodiments of the present invention. In particular, FIG. 3A is a front orthogonal view representation of wetting dam 300 and FIG. 3B a back orthogonal view representation of wetting dam 300. As illustrated, wetting dam 300 includes curved paint shield 302. In embodiments, curved paint shield defines an arcuate surface that includes a front surface, a back surface, a proximal edge, a distal edge, a top edge, and a bottom edge. In an embodiment shown, bottom edge 314A is beveled. In addition, in embodiments, top edge 314B is wider than bottom edge 314A such that opening 320 is defined to provide for liquid flow of liquid coatings. Further illustrated are proximal side shield 304A and distal side shield 304B. Side shields are positioned along the edges of curved paint shield 302. Each side shield extends from top edge 314B and is substantially perpendicular with curved paint shield 302. As noted above, in conventional solutions, paint may spill over the edge of paint trays when loading a paint roller. Side shield embodiments prevent liquid coatings from overflowing the paint tray and allow the liquid coatings to cover and load the roller.

Further illustrated are trailing arms 306 that are coupled to back surface of curved paint shield 302. Trailing arms 306 extend backward from and substantially perpendicular to curved paint shield 302. As illustrated each trailing arm 306 includes slot 308 positioned along a rear portion of the trailing arm. The slots are configured to engage the back wall of a paint tray to removably secure wetting dam embodiments with paint trays. Still further illustrated are support arms 310 positioned between trailing arms 306 and forward of slots 308. As shown, trailing arms 306 are substantially parallel with curved paint shield 302. In order to easily engage and disengage wetting dam embodiments, grab post 312 may be provided that is positioned along a top portion of a trailing arm. In some embodiments, one or more grab posts may be provided along one more trailing arms.

FIG. 4 is an illustrative representation 400 of paint tray 402 and liner 406 in accordance with embodiments of the present invention. Further illustrated is nub 404 around which conforms liner 406 that is captured by wetting dam 408. Embodiments may include one or more nubs as illustrated above for FIG. 2 (216). Nub embodiments may be useful to more securely couple paint trays with liners. As noted above, nubs are optional in embodiments such as illustrated in FIG. 5, which is an illustrative representation 500 of paint tray 502 and liner 506 in accordance with embodiments of the present invention. In this illustrated embodiment, nubs are not utilized in combination with wetting dam 508.

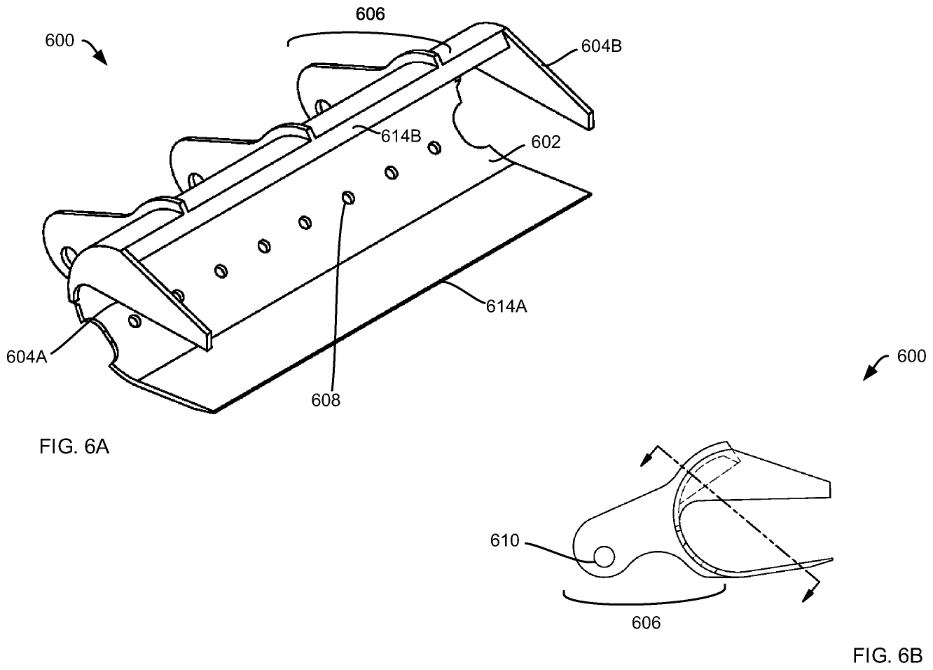

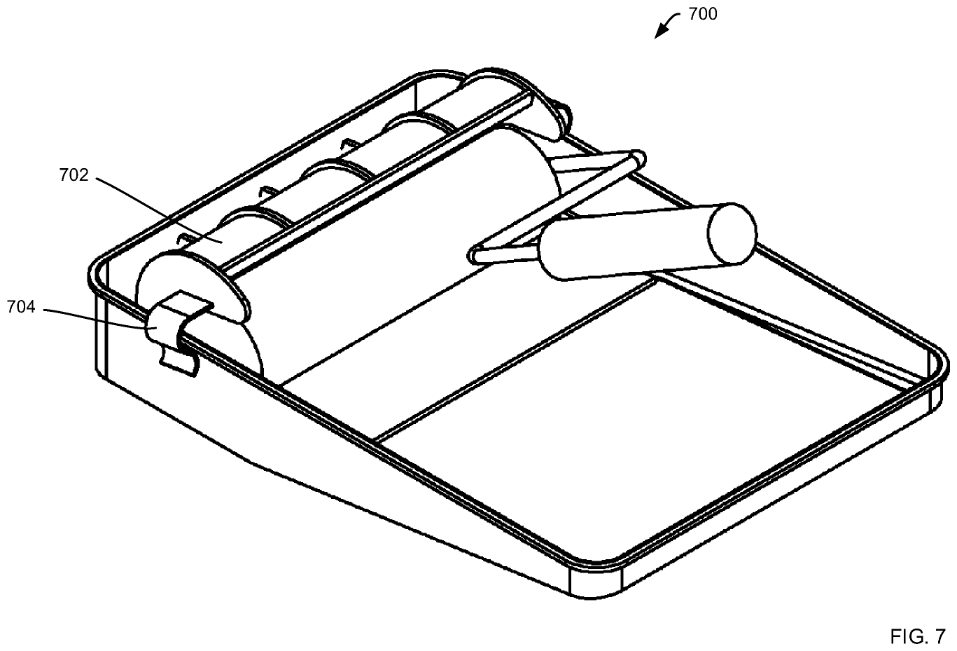

FIGS. 6A-6B are illustrative representations of wetting dam 600 in accordance with embodiments of the present invention. In particular, FIG. 6A is a front orthogonal view representation of wetting dam 600 and FIG. 6B a side view representation of wetting dam 600. As illustrated, wetting dam 600 includes curved paint shield 602. In embodiments, curved paint shield defines an arcuate surface that includes a front surface, a back surface, a proximal edge, a distal edge, a top edge, and a bottom edge. In an embodiment shown, bottom edge 614A is beveled. In addition, curved paint shield 602 includes a number of drain holes 608, which are provided to allow liquid coatings to equalize across the curved paint shield. Further illustrated are proximal side shield 604A and distal side shield 604B. Side shields are positioned along the edges of curved paint shield 602. Each side shield extends from forward of top edge 614B backward and is substantially perpendicular with curved paint shield 602. As noted above, in conventional solutions, paint may spill over the edge of paint trays when loading a paint roller. Side shield embodiments prevent liquid coatings from overflowing the paint tray and allow the liquid coatings to cover and load the roller.

Further illustrated are trailing arms 606 that are coupled to back surface of curved paint shield 602. Trailing arms 606 extend backward from and substantially perpendicular to curved paint shield 602. As illustrated each trailing arm 606 includes drain holes 610 positioned along a rear portion of the trailing arm. The drain holes are configured to allow liquid coatings to equalize across the trailing arms. As shown, trailing arms 606 are substantially parallel with curved paint shield 602.

FIG. 7 is an illustrative representation of a roller wetting system 700 applying coatings to a paint roller in accordance with embodiments of the present invention. In the illustrated embodiment, wetting dam 702 includes side clip 704 positioned on each side shield. Side clips embodiments may be desirable to removably secure wetting dams to paint trays. Side clips may be manufactured from a semi-flexible material that offers sufficient tension to secure the wetting dam but is pliable enough to readily remove from the paint tray.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A roller wetting dam comprising:
a curved paint shield, the curved paint shield defining a front surface, a back surface, a proximal edge, a distal edge, a top edge, and a bottom edge;
a proximal side shield positioned along a portion of the proximal edge and extended from the top edge, wherein the proximal side shield is substantially perpendicular with the curved paint shield;
a distal side shield positioned along a portion of the distal edge and extended from the top edge, the distal side shield substantially perpendicular with the curved paint shield;
a plurality of trailing arms coupled to the back surface of the curved paint shield extending backward from and substantially perpendicular to the curved paint shield, wherein each of the plurality of trailing arms comprises a slot positioned along a rear portion of the trailing arm; and
a plurality of supports positioned between the plurality of trailing arms forward of the slots, wherein the plurality of supports are substantially parallel with the curved paint shield.

2. The roller wetting dam of claim 1 further comprising:
a grab post positioned along a top portion of at least one of the plurality of trailing arms.

3. The roller wetting dam of claim 1, wherein
the bottom edge is beveled.

4. The roller wetting dam of claim 1, wherein
the top edge is wider than the bottom edge such that an opening is defined to provide for liquid flow.

5. The roller wetting dam of claim 1, further comprising:
a proximal tray clip positioned on the proximal side shield; and
a distal tray clip positioned on the distal side shield, wherein
the proximal tray clip and the distal tray clip removably couple the roller wetting dam with a paint tray.

6. A roller wetting system comprising:
a paint tray comprising:
a removable paper towel holder, the removable paper towel holder including a pair of roller support arms positioned along a back portion of the paint tray and extending backward from the back portion; and
roller wetting dam comprising:
a curved paint shield, the curved paint shield defining a front surface, a back surface, a proximal edge, a distal edge, a top edge, and a bottom edge;
a proximal side shield positioned along a portion of the proximal edge and extended from the top edge, wherein the proximal side shield is substantially perpendicular with the curved paint shield;
a distal side shield positioned along a portion of the distal edge and extended from the top edge, the distal side shield substantially perpendicular with the curved paint shield;
a plurality of trailing arms conforming to the back surface of the curved paint shield extending backward from and substantially perpendicular to the curved paint shield, wherein each of the plurality of trailing arms comprises a slot positioned along a rear portion of the trailing arm; and
a plurality of support beams positioned between the plurality of trailing arms forward of the slots, wherein the plurality of support beams are substantially parallel with the curved paint shield.

7. The roller wetting device of claim 6, wherein the paint tray comprises:
a first plurality of raised nubs positioned along a proximal inside corner of the paint tray;
a second plurality of raised nubs positioned along a distal inside corner of the paint tray, wherein the first and second plurality of raised nubs are configured to removably secure the wetting dam along the bottom edge of the curved paint shield.

8. The roller wetting device of claim 7, wherein the first and second plurality of raised nubs are configured to removably secure a removable paint tray liner.

9. The roller wetting dam of claim 6 further comprising:
a grab post positioned along a top portion of at least one of the plurality of trailing arms.

10. The roller wetting dam of claim 6, wherein
the bottom edge is beveled.

11. The roller wetting dam of claim 6, wherein
the top edge is wider than the bottom edge such that an opening is defined to provide for liquid flow.
